(19) United States
(12) Patent Application Publication
(10) Pub. No.: US 2010/0025605 A1
(43) Pub. Date: Feb. 4, 2010

(54) Fuel Valve for Supplying Auxiliary Heating Unit in A Motor Vehicle with Fuel

(75) Inventors: Gunter Galtz, Strasslach-Dingharting (DE); Markus Griner, Gaufing (DE); Heiko Neuner, Hollfeld (DE)

Correspondence Address: FITCH EVEN TABIN & FLANNERY, 120 SOUTH LASALLE STREET, SUITE 1600, CHICAGO, IL, 60603-3406, US

(73) Assignee: WEBASTO AG, Strockdorf (DD)

(21) Appl. No.: 12/090,080

(22) PCT Filed: Oct. 12, 2006
(86) PCT No.: PCT/DE2006/001808

§ 371 Date: Jun. 12, 2009

(30) Foreign Application Priority Data
Oct. 12, 2005 (DE) 10 2005 048 713.0

(51) Int. Cl. F16K 31/02; F01L 3/10

(52) U.S. Cl. 251/129.15; 251/337

(57) ABSTRACT

A fuel valve (10) for supplying fuel to an auxiliary heating device in a motor vehicle comprises a magnet coil (12), a magnet armature (14) and a spring (16) which can be compressed by the magnetic force generated when a pick-up voltage is applied to the magnet coil and causes the magnet armature to move; at a maximum residual voltage applied to the magnet coil, the spring overcomes the magnetic force and expands. According to the invention, a spring force-distance travelled characteristic curve (FWK) is adapted in such a way that it lies, for all relevant values of distance travelled, between a magnetic force-distance travelled characteristic curve with applied pick-up voltage (MWKA) and a magnetic force-distance travelled characteristic curve with applied maximum residual voltage (MWKR).

The invention relates to a fuel valve for supplying an auxiliary heating unit in a motor vehicle with fuel, having a magnet coil, having a magnet armature and having a spring, with it being possible for the spring to be compressed as a result of the application of a pull-in voltage to the magnet coil and the magnetic force which is generated as a result and which triggers a movement of the magnet armature, and with the spring overcoming the magnet force while expanding in the event of a maximum residual voltage being applied to the magnet coil.

Fuel valves of said type serve in particular for the supply of fuel to stationary heaters having an atomizing burner. Said fuel valves serve to obtain defined conditions in the fuel system at all times, specifically by virtue of the valve being opened by means of a supply of current to a magnet coil and the valve being closed again by means of a spring force by means of the coil current being shut off.

In fuel valves of said type, however, there are problems with regard to reliable operation. Since the electrical resistance of the magnet coils increases at high temperatures, a reduced coil current will flow at a given voltage, which results in a reduction of the magnet force. This can have the result that, despite a voltage being applied to the magnet coil, the spring force which holds the valve closed cannot be overcome. The valve consequently cannot open. Other problems can also be observed in the inverse case, when the valve should be closed again. In popular systems, it is specifically normal for a residual voltage of for example 0.4 V to be available at that control output of the control unit which activates the solenoid valve, which residual voltage can typically result in a current consumption in the region of up to 5 mA. Accordingly, the magnet force for triggering the closing process of the valve does not fall to zero but remains at a value corresponding to said coil current. It is therefore sometimes possible that the spring force is not sufficient to overcome said residual magnet force.

The invention is based on the object of overcoming the highlighted problems of the prior art and, in particular, providing a fuel valve which operates reliably under all circumstances.

Said object is achieved by means of the features of the independent claim.

Advantageous embodiments of the invention are specified in the dependent claims.

The invention builds on the generic fuel valve in that a spring-force/travel characteristic curve is adapted such that, for all relevant travel values, it lies between a magnet-force/travel characteristic curve for an applied pull-in voltage and a magnet-force/travel characteristic curve for an applied maximum residual voltage. In this way, it is ensured that the fuel valve can be reliably opened and reliably closed under all relevant circumstances.

In this context, it is likewise provided that, at a maximum permissible temperature, the spring-force/travel characteristic curve lies between a magnet-force/travel characteristic curve for an applied pull-in voltage and a magnet-force/travel characteristic curve for an applied maximum residual voltage. Since the problems in connection with the opening of the fuel valve occur in particular at high temperatures, the adaptation of the spring-force/travel characteristic curve must take into consideration the maximum permissible occurring temperatures.

The adaptation of the spring-force/travel characteristic curve can take place in various ways, of which some are to be mentioned by way of example:

It can be provided that the adaptation of the spring-force/travel characteristic curve is realized by means of a spring with different spring constants in different winding regions.

It can also be provided that the adaptation of the spring-force/travel characteristic curve is realized by means of a spring with different winding gradients in different winding regions.

According to a likewise expedient embodiment of the present invention, it can be provided that the adaptation of the spring-force/travel characteristic curve is realized by means of a spring with different material thicknesses in different winding regions.

It is also possible for the adaptation of the spring-force/travel characteristic curve to be realized by means of a spring with different material stiffness values in different winding regions.

It can also be provided that the adaptation of the spring-force/travel characteristic curve is realized by means of a spring which is composed of different materials in different winding regions.

It is also possible for the adaptation of the spring-force/travel characteristic curve to be realized by means of a plurality of springs which act on the magnet armature individually or together in different travel regions.

The invention is based on the knowledge that the problems with regard to the opening and the closing of a fuel valve can be overcome at all occurring temperatures by adapting the spring-force/travel characteristic curve to the magnet-force/travel characteristic curves. The invention is explained here in connection with a fuel valve which is “closed in the currentless state”. The opening of the valve therefore takes place by supplying the magnet coil with current, while the closing of the valve takes place by shutting off or reducing the current flow. The invention is however not restricted to this. Valves which are “open in the currentless state” are used in connection with various applications. The invention can expediently also be used in this connection.

The invention is now explained in more detail by way of example with reference to the appended drawings on the basis of preferred embodiments. In the drawings:

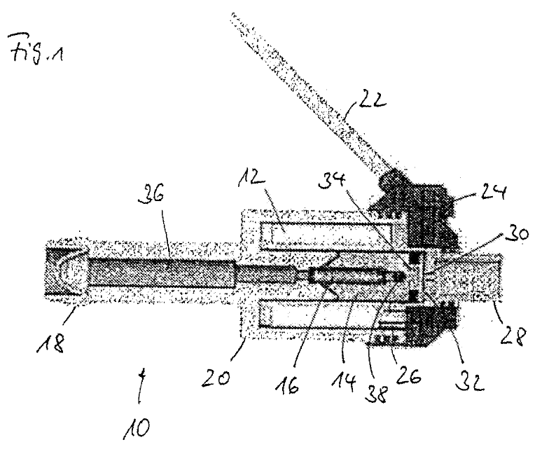

FIG. 1 shows a section illustration of a fuel valve in which the present invention is used, and

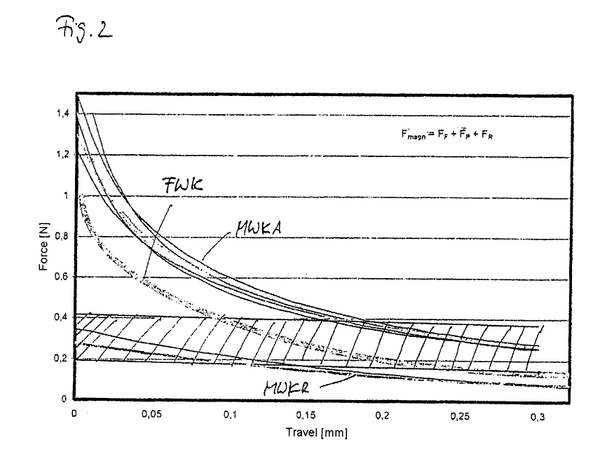

FIG. 2 shows a force/travel diagram for explaining the present invention.

FIG. 1 shows a section illustration of a fuel valve in which the present invention is used. The illustrated fuel valve 10 has a housing 20 in which are arranged a magnet coil 12, a magnet armature 14 and a spring 16. Also arranged on the housing 20 is a fuel supply pipe 18. A voltage can be supplied to the magnet coil 12 by means of a voltage supply 22, 24, 26. The fuel valve 10 has a fuel outflow 28 via which the fuel can be conducted on to the fuel consumer. The fuel outflow 28 is connected by means of a thin fuel line 30 to a valve seat 32. Said valve seat can be sealed off by means of an elastomer seal 34 which is connected to the magnet armature 14. From the fuel supply pipe 18, fuel passes via a stepped-diameter fuel line 36, which is surrounded in the region of the magnet armature 14 by the spring 16, to a transverse bore 38 via which the supplied fuel can pass into the region of the valve seat 32 which is sealed off by means of the elastomer seal 34.

The illustrated fuel valve operates as follows. In the state shown, the spring 16 presses the magnet armature 14 with the elastomer seal 34 against the valve seat 32. The fuel valve 10 is consequently closed. Said state is assumed if the spring force (F_{F}) exceeds the magnet force (F_{magn}) reduced by the pressure force (F_{P}) of the fuel mass flow through the valve and the friction force (F_{R}) resulting from the armature movement in the valve: F_{magn}=F_{F}+F_{P}+F_{R}. The closed state of the fuel valve is assumed in particular in the currentless state of the magnet coil 12 or if only low currents flow through the magnet coil 12. In order to open the fuel valve 10, the current flow through the magnet coil 12 is increased, such that the magnet force F_{magn} increases. If the magnet force F_{magn} exceeds the opposing forces as per the above force equation, then the elastomer seal 34 lifts up from the valve seat 32, and the fuel emerging from the transverse bore 38 can pass via the line 30 to the fuel outlet 28. If the fuel valve 10 is to be closed again, then the current through the magnet coil 12 is reduced, for example to zero or a low value. The spring force can consequently press the magnet armature with the elastomer seal 34 against the valve seat 32 again for the purpose of sealing.

FIG. 2 shows a force/travel diagram for explaining the present invention. Various curves and regions are illustrated in one force/travel diagram. The hatched region shows the force/travel profile of a conventional spring which is used in a fuel valve 10 illustrated in connection with FIG. 1. The force/travel profile is linear and is scattered over a region denoted by the hatching. The MWKA curves show typical profiles of the magnet-force/travel characteristic curve for an applied pull-in voltage. The curves MWKR show typical magnet-force/travel characteristic curves for an applied residual voltage, which can also be applied to the magnet coil in the event of the re-closure of the fuel valve. The critical regions of this diagram lie at small travel values and, at the other side of a non-critical region of medium travel values, at large travel values. If it is for example assumed that the fuel valve is closed at a travel value of 0.3 mm, then it can be seen that the hatched region, that is to say the possible occurring forces of a conventional spring, lies partially above the MWKA curves. This means that the magnet force would not be sufficient to move the magnet armature counter to the spring force. If one again considers the region at a travel value of zero, which corresponds to the fully open state of the fuel valve, then it can also be seen here that, when a residual voltage is applied corresponding to the MWKR curves, a part of the hatched region corresponding to the conventional spring lies below the MWKR curves. It can consequently be the case that the spring force is not sufficient to overcome the residual magnet force corresponding to the MWKR curves.

On the basis of the invention, the problems both when the fuel valve is closed and also when the fuel valve is open are overcome. In a fuel valve according to the invention, the spring-force/travel characteristic curve runs for example as per the curve FWK. Said curve lies between the MWKA and MWKR curves at all travel values, so that the discussed non-functionality can no longer occur at the travel values for a fully closed fuel valve (0.3 mm) and fully open solenoid valve (0).

The features of the invention disclosed in the above description, in the drawings and in the claims can be essential to the realization of the invention both individually and also in any desired combination.

### LIST OF REFERENCE SYMBOLS

10 Fuel valve
12 Magnet coil
14 Magnet armature
16 Spring
18 Fuel supply pipe
20 Housing
22 Voltage supply
24 Voltage supply
26 Voltage supply
28 Fuel outflow
30 Fuel line
32 Valve seat
34 Elastomer seal
38 Transverse bore

1. A fuel valve for supplying an auxiliary heating unit in a motor vehicle with fuel, having a magnet coil, having a magnet armature and having a spring, with it being possible for the spring to be compressed as a result of the application of a pull-in voltage to the magnet coil and the magnetic force which is generated as a result and which triggers a movement of the magnet armature, and with the spring overcoming the magnet force while expanding in the event of a maximum residual voltage being applied to the magnet coil, characterized in that a spring force/travel characteristic curve (FWK) is adapted such that, for all relevant travel values, it lies between a magnet-force/travel characteristic curve for an applied pull-in voltage (MWKA) and a magnet-force/travel characteristic curve for an applied maximum residual voltage (MWKR).

2. The fuel valve of claim 1, characterized in that, at a maximum permissible temperature, the spring-force/travel characteristic curve (FWK) lies between a magnet-force/travel characteristic curve for an applied pull-in voltage (MWKA) and a magnet-force/travel characteristic curve for an applied maximum residual voltage (MWKR).

3. The fuel valve claim 1, characterized in that the adaptation of the spring-force/travel characteristic curve (FWK) is realized by means of a spring with different spring constants in different winding regions.

4. The fuel valve of claim 1, characterized in that the adaptation of the spring-force/travel characteristic curve (FWK) is realized by means of a spring with different winding gradients in different winding regions.

5. The fuel valve of claim 1, characterized in that the adaptation of the spring-force/travel characteristic curve (FWK) is realized by means of a spring with different material thicknesses in different winding regions.

6. The fuel valve of claim 1, characterized in that the adaptation of the spring-force/travel characteristic curve (FWK) is realized by means of a spring with different material stiffness values in different winding regions.

7. The fuel valve of claim 1, characterized in that the adaptation of the spring-force/travel characteristic curve (FWK) is realized by means of a spring which is composed of different materials in different winding regions.

8. The fuel valve of claim 1, characterized in that the adaptation of the spring-force/travel characteristic curve (FWK) is realized by means of a plurality of springs which act on the magnet armature individually or together in different travel regions.
